(19) United States
(12) Patent Application Publication
(10) Pub. No.: US 2007/0129154 A1
(43) Pub. Date: Jun. 7, 2007

(54) Propeller shaft assembly with integrated stub portion

(76) Inventor: Brian Valovick, Royal Oak, MI (US)

Correspondence Address: GKN DRIVELINE NORTH AMERICA, INC, 3300 UNIVERSITY DRIVE, AUBURN HILLS, MI, 48326, US

(21) Appl. No.: 11/295,402

(22) Filed: Dec. 6, 2005

(51) Int. Cl. F16D 3/84

(52) U.S. Cl. 464/170

(57) ABSTRACT

A propeller shaft assembly of a vehicle comprises an inner tube and an outer tube in which one of the inner and outer tubes includes a stub portion integrally formed with a shaft portion. A method for making a stub portion integrally formed with the shaft portion is disclosed. The propeller shaft assembly includes a fully supportive feature in which the outer tube of the propeller shaft assembly is fully supportive along the torque path by the inner tube to increase the strength of the propeller shaft assembly.

### BACKGROUND

In some conventional vehicles, for example, a vehicle driveshaft or propeller shaft (propshaft) transmits torque from the transmission through a differential to the wheels of the vehicle. In many cases, such a propshaft uses a spline tube having a center portion fitted at one end with a stub, and at the other end with a spline. Typically, both the stub and spline are machined separate from the center portion and then attached by means of welding.

### SUMMARY

In one embodiment, a tube for a propshaft assembly of a vehicle comprises a stub portion, and a shaft portion, wherein the stub portion and the shaft portion are an integral component.

In another embodiment, a propeller shaft assembly comprises an inner tube having a spline portion and a stub portion; and an outer tube having a spline portion and a stub portion, wherein the stub portion of the inner and outer tubes is integrally formed with the spline portion.

A method for forming a tube for a propshaft assembly of a vehicle comprises the steps of:

providing a tubular component; and

forming a shaft portion and a stub portion at one end of the tubular component, whereby the stub portion is integrally formed with the shaft portion.

### BRIEF DESCRIPTION OF THE DRAWINGS

The invention will now be described, by way of example, with reference to the accompanying drawings, in which:

FIG. 1 is a cross-sectional view of an inner tube for a propshaft assembly with an integrated stub portion according to an embodiment of the invention;

FIG. 2 is a cross-sectional view of an outer tube for a propshaft assembly with an integrated stub portion according to another embodiment of the invention;

FIG. 3 is a cross-sectional view taken along line III-III of FIG. 1;

FIG. 4 is a cross-sectional view taken along line IV-IV of FIG. 2;

FIG. 5 is a flow chart of a method of the invention;

FIGS. 6-9 are cross-sectional views of the inner and outer tubes of FIGS. 1 and 2 being formed with an integrated stub portion by using a method of the invention;

FIG. 10 is a cross-sectional view of a propshaft assembly including inner and outer tubes with integrated stub portions formed using a method of the invention in a non-contracted or non-telescoping state;

FIG. 11 is an enlarged view of the propshaft assembly of FIG. 10 including the inner tube with an integrated stub portion and an outer tube that is fully supported by the inner tube according to the invention;

FIG. 12 is another enlarged view of the propshaft assembly of FIG. 10 including the inner tube with an integrated stub portion and an outer tube that is fully supported by the inner tube according to the invention;

FIG. 13 is a cross-sectional view of a propshaft assembly including inner and outer tubes with integrated stub portions formed using a method of the invention in a contracted or telescoping state; and

FIG. 14 is a cross-sectional view of a propeller shaft assembly including an inner tube with an integrated stub portion and an outer tube that is fully supported by the inner tube according to another embodiment of the invention.

### DETAILED DESCRIPTION

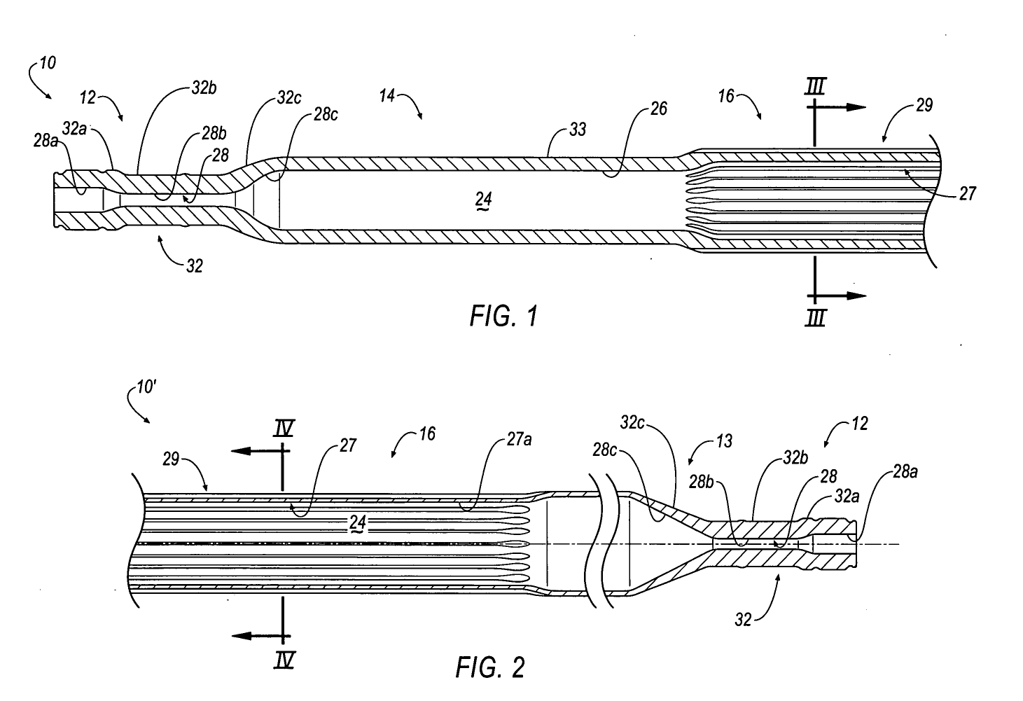

Referring now to FIG. 1, a male or inner tube 10 for a propshaft assembly is shown according to an embodiment of the invention. In general, the inner tube 10 includes a generally round and/or tubular member that has a stub portion 12, shaft portion 14 and a spline portion 16. In an embodiment, the stub portion 12 is on one axial end of the shaft portion 14, which is opposite from the spline portion 16. According to an aspect of the invention, the stub portion 12, shaft portion 14 and spline portion 16 are an integral component. By this, the spline tube 10 is constructed of one unitary piece of material, such as a piece of continuous tube material, that is formed into the various components of the stub portion 12, shaft portion 14 and spline portion 16. In an embodiment, such a integral configuration does not include individual stub, shaft and spline portions connected by welds, adhesions or other similar attachments. Of course, one skilled in the art will readily recognize that variations to the illustrated embodiments are contemplated by the invention.

In an embodiment, the shaft portion 14 and stub portion 12 include a hollow interior portion 24. For the shaft portion 14, the hollow interior portion 24 is defined by shaft inner surface 26. For the stub portion 12, the interior portion 24 is defined by stub interior surface 28.

A shaft outer surface 33 defines an exterior surface of the shaft portion 14. A shaft inner surface 26, located opposite to the shaft outer surface 33, defines an interior region of the shaft portion 14. Similarly, a stub outer surface 32 defines an outer surface of the stub portion 12. A stub interior surface 28, located opposite to the stub outer surface 32, defines an interior region of the stub portion 12. As can be generally seen from FIG. 1, in an embodiment, the stub interior surface 28 generally follows the contours of the stub outer surface 32. Similarly, in an embodiment, the shaft inner surface 26 generally follows the contours of the shaft outer surface 33. Accordingly, for example, the stub portion 12 transitions from a first stub outer region 32a, having a given diameter, to a second stub outer region 32b having a relatively smaller diameter than the diameter of the first stub outer region 32a. The second stub outer region 32b then transitions to the shaft outer surface 33 through the third stub outer region 32c. Similarly, the stub interior surface 28 transitions from a first stub inner region 28a, having a given diameter, to a second stub inner region 28b having a relatively smaller diameter than the first stub inner region 28a. The second stub inner region 28b then transitions to the shaft inner surface 26 through a third stub inner region 28c. Therefore, in an embodiment, the diameter of the shaft inner surface 26 changes in accordance with the shaft outer surface 33 such that the diameter of the stub interior surface 28 changes in accordance with the stub outer surface 32. Therefore, in one embodiment, the diameter of the outer surface of the spline tube 10 changes in accordance with the diameter of the inner surface of the spline tube 10. Of course, it will be understood that the changes in contour of either the shaft inner surface 26 or the stub interior surface 28 do not necessarily exactly change in contour with respect to shaft outer surface 33 or stub outer surface 32.

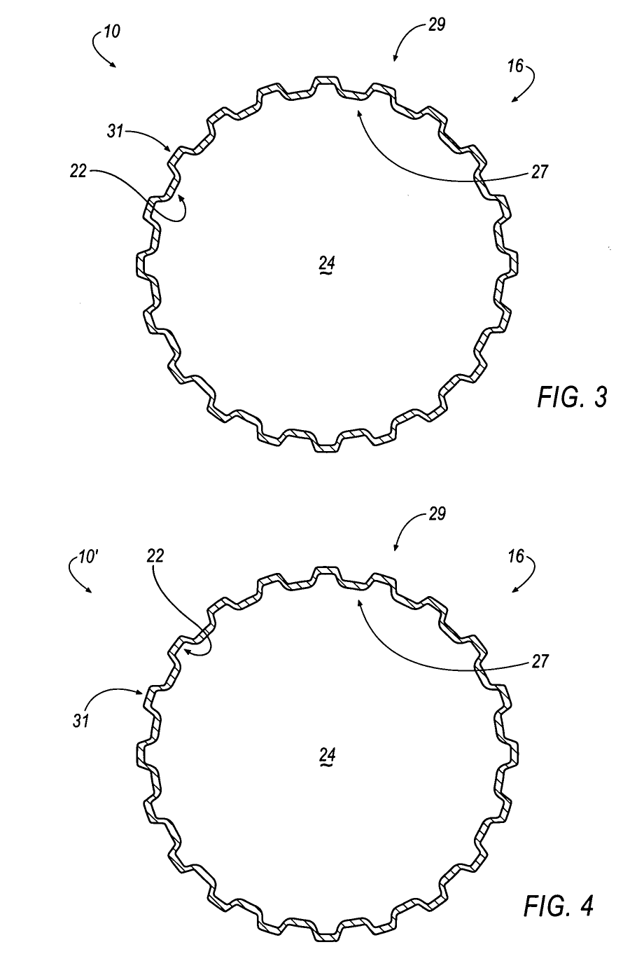

Referring now to FIGS. 1 and 3, the spline portion 16 is described in greater detail. FIG. 3 illustrates a cross-section of line III-III in FIG. 1 of the spline portion 16 according to an embodiment. As shown in FIG. 3, the spline portion 16 generally includes an inner surface 27 having a plurality of inwardly projecting splines 22 that are circumferentially formed upon an inside surface of the spline portion 16. An exterior surface 29 includes a plurality of outwardly projecting splines 31 that substantially correspond to the geometry of the inwardly projecting splines 22.

As with the stub portion 12, the exterior surface 29 has a geometry that corresponds to that of the inner surface 27. For example, at regions 37, both exterior surface 29 and inner surface 27 transition from a larger diameter proximate the spline portion 16 to a reduced diameter proximate to shaft portion 14. Thus, as shown, the diameter of the spline tube 10 has a greatest diameter at the spline portion 16, steps down to a smaller diameter at the shaft portion 14, and has a smaller diameter at the stub portion 12. In one embodiment, the spline portion 14 has a largest outside diameter of, for example, approximately 65 mm, and the stub portion 16 has a smaller diameter of, for example, approximately 20 mm. Of course, other geometries and diameters are contemplated, and the invention should not be considered as limited by the description provided herein.

Referring now to FIGS. 2 and 4, a female or outer tube 10′ for a propshaft assembly is shown according to another embodiment of the invention. In FIG. 2, a spline tube 10′ is shown having a stub portion 12 and a spline portion 16. As shown in FIG. 4, which illustrates the spline portion along line IV-IV in FIG. 2, the spline portion 16 includes an outer surface 29 having a plurality of outwardly projecting splines 31 that are circumferentially formed upon the outer shaft 14. As shown, the inner surface 27 of the spline portion 16 includes a plurality of inwardly projecting splines 22 that substantially correspond to the geometry of the splines 31 on the exterior surface of the spline portion 16.

As shown in FIG. 2, the outer tube 10′ includes a hollow interior 24. Hollow interior 24 is generally defined by the stub interior surface 28 and spline interior surface 27. As can be generally seen from FIG. 2, the stub interior surface 28 generally follows the contours of the stub outer surface 32. Accordingly, for example, the stub portion 12 transitions from the first stub outer region 32a, having a given diameter, to a second stub outer region 32b with a relatively smaller diameter from the diameter of the first stub outer region 32a. The second stub outer region 32b then transitions to the spline portion 16 through the third stub outer region 32c. Similarly, the stub interior surface 28 transitions from a first stub inner region 28a, having a given diameter, to a second stub inner region 28b having a relatively smaller diameter than the diameter of the first stub inner region 28a. The second stub inner region 28b then transitions to the spline inner surface 27 through a third stub inner region 28c. Therefore, in an embodiment, the diameter of the stub interior surface 28 changes in accordance with the stub outer surface 32.

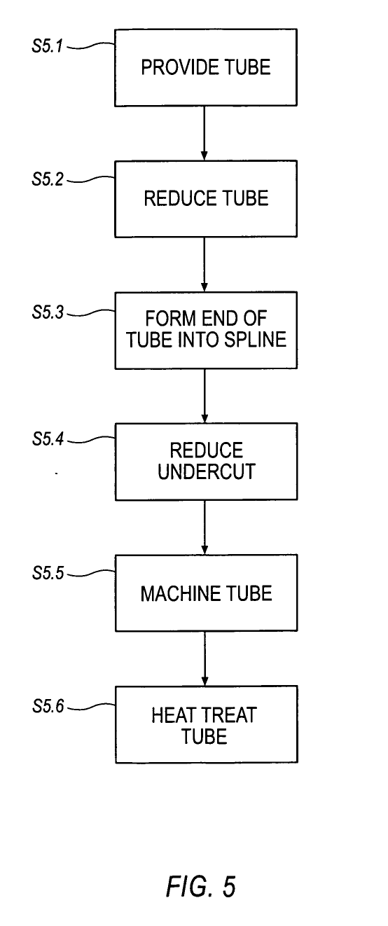

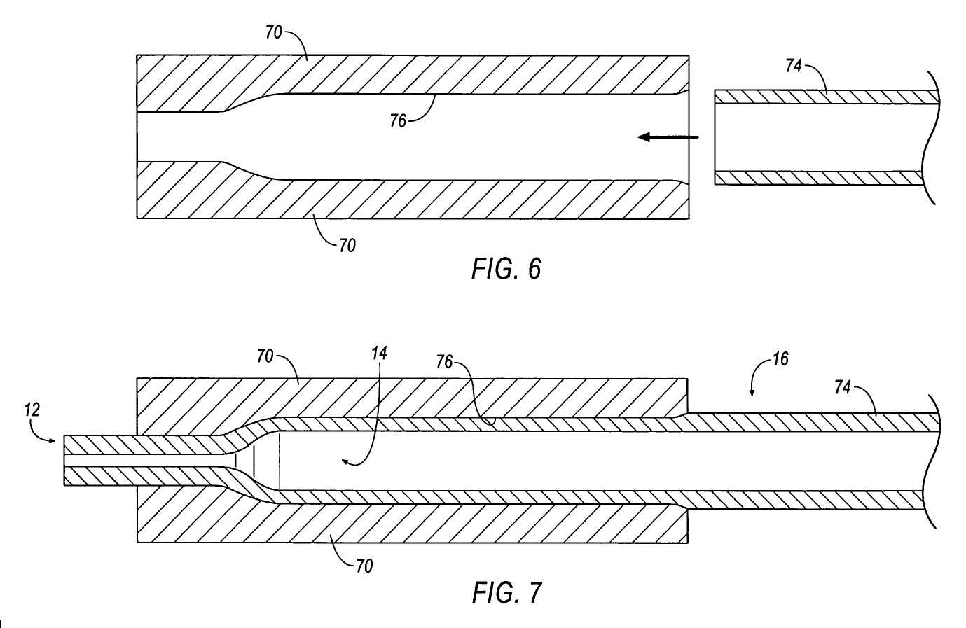

Referring now to FIG. 5, a method for forming the inner and outer tubes 10, 10′ from a unitary piece of tubing or stock is generally shown and described. Initially, a unitary piece of material or stock, such as a tube 74 (Step S5.1). Next, one end of the tube 74 is inserted into an inner diameter 76 of a die 70 (in the direction of the arrow in FIG. 6) such that the tube is reduced (Step S5.2). As shown in FIGS. 6 and 7, the inner diameter 76 has a shape that corresponds substantially to the outer surface 33 of the shaft portion 14 and a preliminary shape for the stub portion 12.

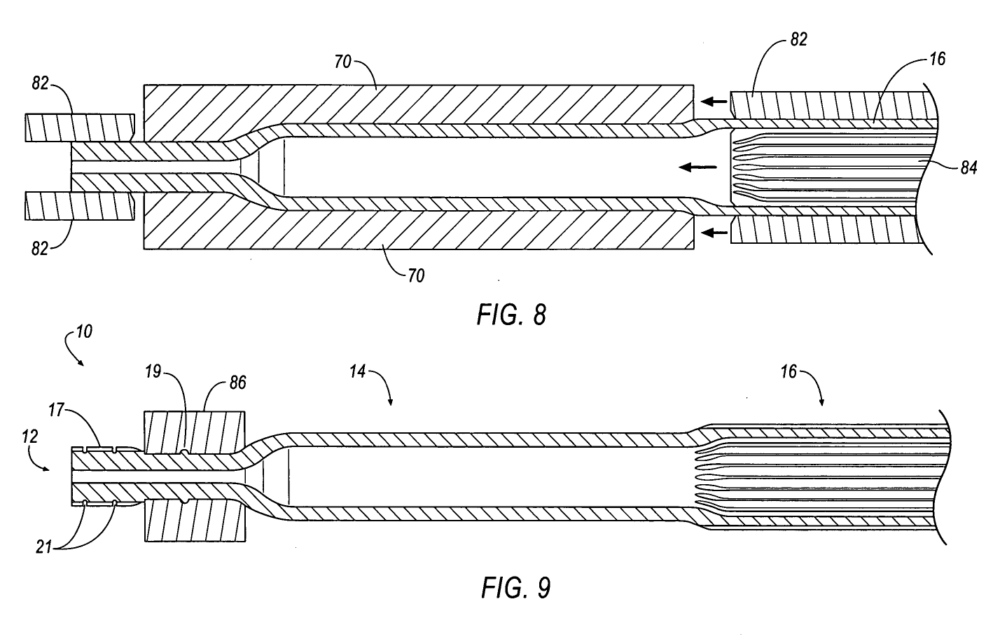

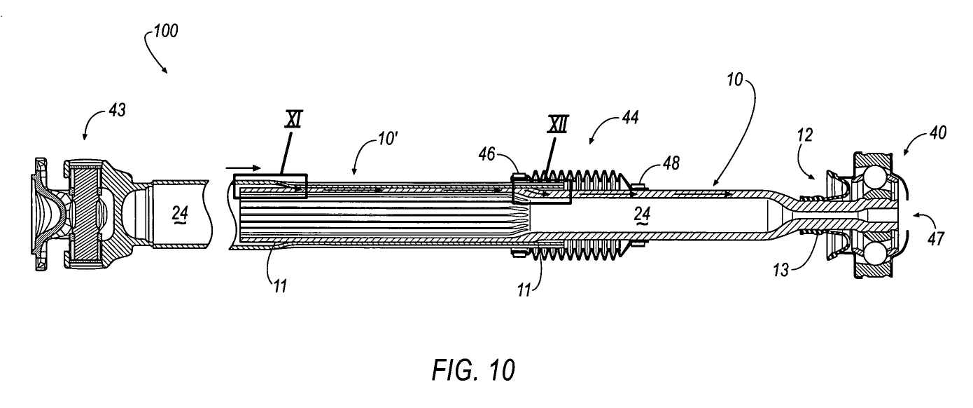

Then, the spline portion 16 at formed at the other end of the tube (Step S5.3). The tube may undergo a heat treatment step prior to forming the splines 22, for example, as described in U.S. Patent Application Publication 2004/0163743, the entire contents of which are incorporated herein by reference. To form the spline portion 16, an outer die 82 and inner die 84 are driven axially along the spline portion 16, as shown in FIG. 8. For the inner tube 10 shown in FIGS. 1 and 3, the outer die 82 has a spline configuration disposed on an interior surface thereof that forms the splines 27 of the exterior surface 29 of the spline portion 16 when the die 84 is driven axially along the spline portion 16. For the outer tube 10′ shown in FIG. 2 and 4, the inner die 84 as a plurality of splines formed on an outside diameter thereof for forming the splines on the inner surface 27 of the spline portion 16 when the die 84 is driven axially along the spline portion 16. The resultant outer tube 10′ with integrated stub portion 12 is shown in FIG. 10. In addition, the die 82 may be used to form splines 17 on the stub portion 12, as shown in FIGS. 8 and 9. Once the spline portion 16 is formed, the dies 70, 82 and 84 are removed.

Then, one of the tube is further reduced or undercut for a boot 13 of the constant velocity (CV) joint 40 (Step S5.4). As shown in FIG. 9, a die 86 applies pressure to a portion of the stub portion 12 to form a raised portion 19 on the stub portion 12 for the boot 13.

Next, the tube may undergo finish machining of one or more retention features 21, such as circumferentially formed grooves, or the like, (Step S5.5), as shown in FIG. 9. Then, the tube may undergo an optional heat treatment process (Step S5.6).

Referring now to FIGS. 10-12, a propshaft assembly 100 includes the inner and outer tubes 10, 10′ with an integrated stub portion 12 according to an embodiment of the invention. A constant velocity (CV) joint 40 engages the integrated stub portion 12 of the inner and outer tubes 10, 10′. The constant velocity joint 40 may be any desirable type, for example, a DOJ plug-in type of CV joint. At an end opposite to the stub portion 12 of the inner tube 10, spline portion 16 of the inner tube 10 is shown being in a splined engagement with the spline portion 16 of the outer tube 10′. The outer tube 10′ provides rotational output from an engine, transmission or other output device 43, through the inner and outer tubes 10, 10′ and to CV joint 40. The interior portion 24 of the inner and outer tubes 10, 10′ define an open path from the output device 43, through the inner and outer tubes 10, 10′, and to an output area 47 of the CV joint 40.

In an embodiment, the spline connection between the inner and outer tubes 10, 10′ allows for plunging, otherwise known as a slip spline. Such plunging allows the outer tube 10′ to telescope inward toward the inner tube 10 under certain load conditions. The outer tube 10′ and the inner tube 10 are connected by an accordion seal or boot 44. The accordion seal 44 is clamped to the inner 10 by a clamp 48 and clamped to the outer tube 10′ by a clamp 46. The accordion seal 44 allows the outer tube 10′ and the inner tube 10 to be in a telescoping relationship while preventing the entry of dirt or other debris at an area where the inner and outer tubes 10, 10′ meet.

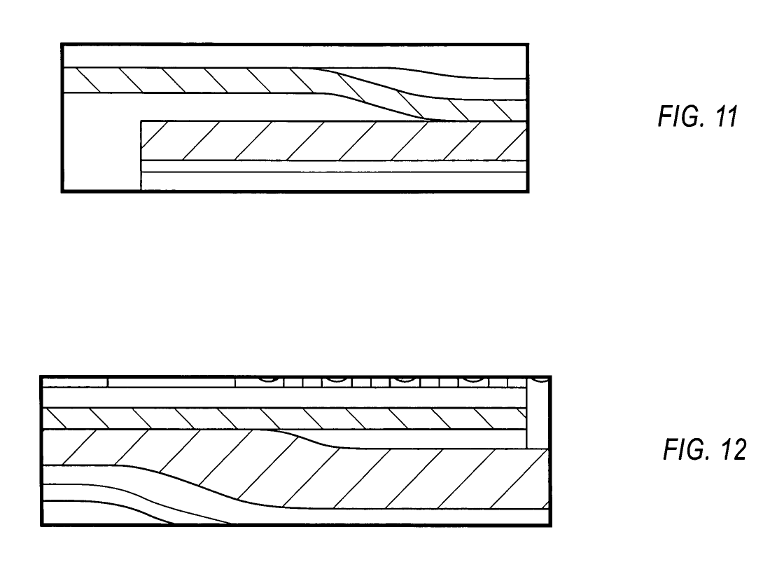

In this embodiment of the propeller shaft assembly 100, the outer tube 10′ is fully supported by the inner tube 10. This fully supported spline feature, shown generally at 11, is made possible by a reduction of the diameter of the inner tube 10, which allows for the complete overlap of the spline portion 16 of the inner and outer tubes 10, 10′, as shown in FIGS. 11 and 12. The fully supported spline feature 11 assures maximum component strength by having internally-formed splines of the outer tube 10′ support the externally-formed splines of the inner tube 10, thereby cooperating to absorb the transition of stress from the relatively large tube diameter of the outer tube 10′ to the reduced tube diameter of the inner tube 10 in a manner to assure maximum strength of the propeller shaft assembly 10. By having full support of the inner and outer tubes 10, 10′ within the path of the torque being transmitted through the inner and outer tubes 10, 10′ (indicated by the arrows in FIG. 10), the combined moment of inertia and the component strength will be maximized. In addition, the propshaft assembly 100 is able to collapse without obstructions.

In other words, the fully supported spline feature 11 reduces the stress in the outer tube 10′ during torsional loading, thus resulting in a higher yield and ultimate strength of the propeller shaft assembly 100. The reduction allows unobstructed driveline expansion or contraction under normal vehicle operation for the slip spline design, while still maintaining a fully supported propeller shaft assembly 100. The locked spline feature would be fully supported as well for the advantages in torsional strength. The reduction on the inner tube 10′ provides an unobstructed collapse during a severe dynamic event, such as a vehicle crash.

It will be appreciated that the invention is not limited to a propeller shaft assembly having a slip spline arrangement, and that the invention can be practiced with other type of splined arrangements. For example, the inner and outer tubes 10, 10′ with an integrated stub portion 12 can be formed and used for a propeller shaft assembly having a locked spline arrangement.

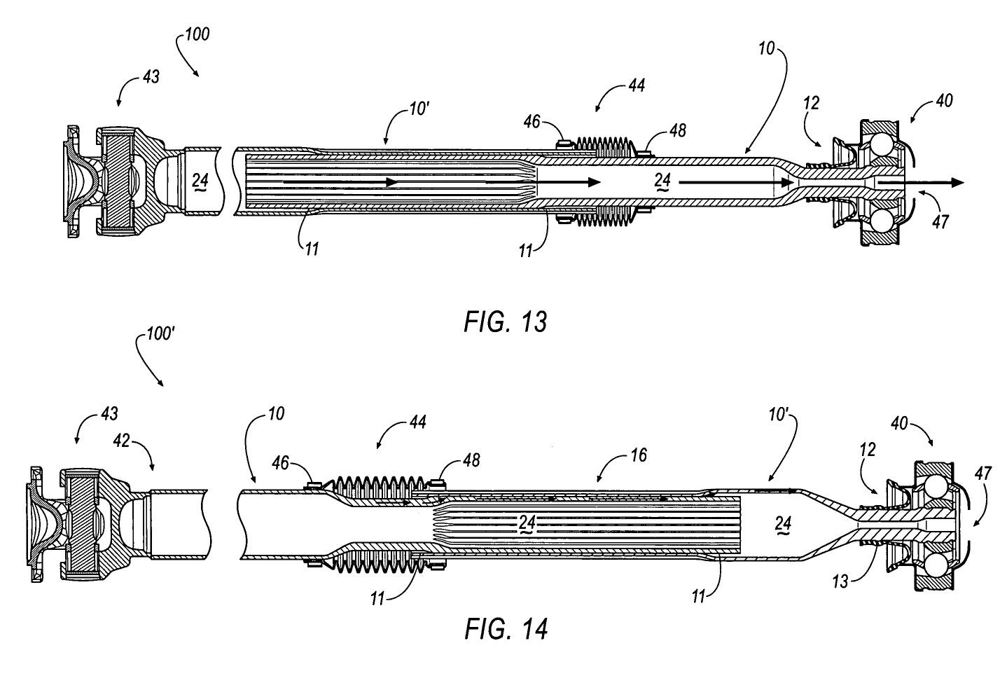

In FIG. 10, the propeller shaft assembly 100 is shown in a non-contracted or non-telescoping state. In FIG. 13, the outer tube 10′ is shown being telescopingly moved over the inner tube 10 in a direction indicated by the arrows (or the inner tube 10 is shown being telescopingly moved into the outer tube 10′). During this telescoping movement, the outer tube 10′ moves over the spline portion of the inner tube 10 to cause the accordion seal 44 to contract and cause a reduction in the volume defined by the interior portions 24 of the inner and outer tubes 10, 10′. This reduction in volume causes the air within interior portions 24 to move longitudinally through the interior portions 24 and exit from the output area 47, as indicated by the arrows.

The material strength, diameter, and material thickness determine the maximum strength of the inner and outer tubes 10, 10′. When a spline is formed to the inner and outer tubes 10, 10′, the tube torsional strength is reduced due to the reduction in the moment of inertia and an increase in stress concentrations due to the formation of the spline. Test results have indicated that propshaft assembly with inner and outer tubes 10, 10′ having spline portion 16 may observe a significant reduction in strength for a given tube thickness when not fully supported.

Referring now to FIG. 14, another embodiment of a propeller shaft assembly 100′ is shown and described. In this embodiment, the outer tube 10′ is fully supported by the inner tube 10, similar to the fully supported feature 11 of the propeller shaft assembly 10 shown in FIGS. 10-13. In this embodiment, the length of the offset between the end of the outer tube 10′ and the connecting component, such as the CV joint 40, can tune the length of tube collapse. Alternatively, the offset of the inner tube 10 and the connecting component 43 can be designed as the length of tube collapse. The connecting component 40, 43 can be a cardan, rubber coupling, center bearing assembly of a CV joint.

It should be noted that the method of making the inner tube 10 shown and described in FIG. 14 is slightly different than the method of making the inner tube 10 (and outer tube 10′) as shown and described in FIGS. 5-9. First, the inner tube 10 undergoes a first reduction in the area of the spline portion 16. Then, the externally-formed splines are formed on the exterior surface of the inner tube 10, similar to the inner tube 10 as shown and described in FIGS. 5-9. Next, a portion of the inner tube 10 undergoes a second reduction to form the fully supported spline feature 11 for supporting the outer tube 10′ along the torque path by the inner tube 10 to increase the strength of the propeller shaft assembly 100′. Alternatively, the reduction of the inner tube 10 to form the fully supported spline feature 11 can be performed prior to the reduction in the area of the spline portion 16. Also, a pre-heating step may be necessary for some materials to reduce stresses in the spline area as the first reduction has work hardened the material in the area where the splines are formed in the spline portion 16.

The invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A tube for a propshaft assembly of a vehicle, comprising:
a stub portion; and
a shaft portion,
wherein the stub portion and the shaft portion are an integral component.

2. The tube according to claim 1, wherein the stub portion has a inside stub surface that defines a hollow interior portion of the stub portion.

3. The tube according to claim 2, wherein the stub portion has a stub outside surface, and wherein a geometry of the inside stub surface substantially corresponds to a geometry of the outside stub surface.

4. The tube according to claim 3, wherein the shaft portion has an inside shaft surface that defines a hollow interior portion of the shaft portion.

5. The tube according to claim 4, wherein the shaft portion has a shaft outside surface, and wherein a geometry of the inside shaft surface substantially corresponds to a geometry of the shaft outside surface.

6. The tube according to claim 1, further comprising:
a spline portion positioned on an opposite axial end from the stub portion, wherein the spline portion is integral with the shaft portion.

7. The tube according to claim 6, wherein the spline portion further comprises:
a spline surface having splines disposed thereon; and
a surface opposite to the spline surface.

8. The tube according to claim 7, wherein a geometry of the spline surface substantially corresponds to a geometry of the opposite surface.

9. The tube according to claim 6, wherein the spline surface is an inside spline surface and the opposite surface is an outside surface.

10. The tube according to claim 9, wherein the outside surface of the spline portion has a larger diameter than the shaft portion, and wherein the shaft portion has a larger diameter than the stub portion.

11. The tube according to claim 6, wherein the spline surface is an outside surface and the opposite surface is an inside surface.

12. The tube according to claim 6, wherein a reduction from the spline portion to the stub portion is less than or equal to 65 mm to 20 mm.

13. A method for forming a tube for a propshaft assembly of a vehicle, comprising the steps of:
providing a tubular component; and
forming a shaft portion and a stub portion at one end of the tubular component, whereby the stub portion is integrally formed with the shaft portion.

14. The method according to claim 13, wherein the step of forming is performed by reducing a diameter of the axial end of the tubular component.

15. The method according to claim 14, wherein the step of forming is performed by rotary hammering.

16. The method according to claim 13, wherein the stub portion has a stub inside surface after the forming step that defines a hollow interior portion of the stub portion.

17. The method according to claim 16, wherein the stub portion has a outside stub surface after the forming step, and wherein a geometry of the inside stub surface substantially corresponds to a geometry of the outside stub surface.

18. The method according to claim 17, wherein the shaft portion has an inside shaft surface that defines a hollow interior portion of the shaft portion.

19. The method according to claim 18, wherein the shaft portion has a shaft outside surface, and wherein a geometry of the inside shaft surface substantially corresponds to a geometry of the shaft outside surface.

20. The method according to claim 13, further comprising forming a spline portion on an opposite axial and from the stub portion.

21. The method according to claim 20, wherein the spline portion further comprises:
an inside spline surface having splines disposed thereon; and
an outside spline surface.

22. The method according to claim 21, wherein the inside spline surface is formed by cold extrusion.

23. The method according to claim 21, wherein a geometry of the inside spline surface substantially corresponds to a geometry of the outside spline surface.

24. A propeller shaft assembly, comprising:
an inner tube having a spline portion and a stub portion; and
an outer tube having a spline portion and a stub portion,
wherein the stub portion of the inner and outer tubes is integrally formed with the spline portion.

25. The propeller shaft assembly according to claim 24, wherein the outer tube is fully supported by the inner tube for reducing stress in the outer tube during torsional loading, thereby resulting in a higher yield and strength of the propeller shaft assembly.
